(19) United States
(12) Patent Application Publication
(10) Pub. No.: US 2020/0160887 A1
(43) Pub. Date: May 21, 2020

(54) HASH TABLE RESPONSIVE CONTENT ALTERATION

(71) Applicant: Warner Bros. Entertainment Inc., Burbank, CA (US)

(72) Inventors: Massimilliano Gasparri, Los Angeles, CA (US); Darcy Antonellis, Granada Hills, CA (US); Jinha Kim, Torrance, CA (US); Kim Vu, South Pasadena, CA (US)

(21) Appl. No.: 16/532,417

(22) Filed: Aug. 5, 2019

Related U.S. Application Data
(63) Continuation of application No. 13/105,463, filed on May 11, 2011, now abandoned.
(60) Provisional application No. 61/333,681, filed on May 11, 2010.

(51) Int. Cl. G11B 27/10; G11B 27/28

(52) U.S. Cl. CPC G11B 27/105; G11B 2220/2562; G11B 27/28

(57) ABSTRACT

A method for operating a media player includes extracting a set of identifiers from a digital medium holding an encoded video content, using a media player. The method further includes transmitting the set of identifiers to an identification service to obtain status information. The method further includes controlling at least one function of the media player used to provide video output from the media player, in response to the status information. Extracting the set of identifiers may include extracting five identifiers comprising a volume name, a book type, and a time stamp for the digital medium, a file directory hash, and a watermark description. The method may be embodied in a media player or encoded instructions for a media player.

### CROSS-REFERENCE TO RELATED APPLICATION

This application is a continuation of application Ser. No. 13/105,463 filed May 11, 2011, which claims priority pursuant to 35 U.S.C. § 119(e) to U.S. provisional application Ser. No. 61/333,681, filed May 11, 2010, which applications are specifically incorporated herein, in their entireties, by reference.

### BACKGROUND

### 1. Field

The present disclosure relates to hash table responsive content alteration in digital media.

### 2. Description of Related Art

For a given movie property, a studio may publish and distribute identical or essentially identical releases for different end uses. For example, for a given movie property, a studio may publish and distribute a medium containing a version of the movie and related content, which it sells and distributes for sale directly to consumers, and to an intermediary company for rental to consumers. Typically, the retail price for sale to the consumer is substantially higher than the retail price for renting the release. Media distributed for sale are may be identical to media distributed for rental and may be identified using the same stock keeping unit (SKU) number. Thus, rental consumers may be assured of receiving the same content as purchasers of the release.

A problem with this distribution model is that some rental consumers chose to illegally copy content from rented media, and thereby obtain the same or similar benefits as purchasers of the discs, at a substantially lower cost. This is unfair to purchasers of the release and erodes the available purchase market for the publisher. At the same time, publishers generally desire to preserve the ability of purchase consumers to make copies of legitimately purchased media for licensed uses, for example, as a backup for purchased content, or for play on a device using a different recording medium.

### SUMMARY

It would be desirable, therefore, to provide a technology whereby player devices can distinguish between digital audio-video content.

Enabling the player or copying device to distinguish digital content may have various useful applications. For one, the technology may thereby prevent illegal copying of rented content. In addition, the technology may enable additional marketing or presentation of offers to end users, depending on the intended use. For example, special offers for related content may be offered to viewers of purchased discs, while viewers of rented discs may be offered an opportunity to purchase discs containing the same releases as the rental discs.

In an aspect, method for operating a media player to provide end-use differentiation in digital media may include extracting a set of identifiers from a digital medium holding an encoded video content, using a media player. The method may further include transmitting the set of identifiers to an identification service to obtain status information indicating a title for the video content, and an authorization status of the digital medium. The method may further include controlling at least one function of the media player used to provide video output from the media player, in response to the status information. Extracting the set of identifiers may include extracting five identifiers comprising a volume name, a book type, and a time stamp for the digital medium, a file directory hash, and a watermark description.

In other aspects, the method may include decoding and hashing a file directory of the digital medium to obtain the file directory hash. The method may include processing the video content using a watermark-reading tool to obtain the watermark description.

In other aspects, the method may include disabling play of the video content in response to the authorization status indicating the digital medium is not authorized for play; for example, if the medium is deemed to be pirated because of a mismatch between any of the set of identifiers extracted from the digital medium and a corresponding set of identifiers previously registered with the identification service for the digital medium. In addition, the method may include enabling play and copying of the video content, in response to the authorization status indicating the digital medium is authorized for play and the end-use designation is for sell-through. The method may further include enabling play while disabling copying of the video content, in response to the authorization status indicating the digital medium is authorized for play and the end-use designation is for rental.

In another aspect, the method may include selecting a message for outputting from the video player, in response to the status information. For example, the media player may select and output a marketing message directed to a rental customer, in response to receiving an end-use designation for rental. For further example, the media player may select and output a different marketing message directed to a purchaser, in response to receiving an end-use designation for sell-through.

The method and operations described above may be embodied in a media player or encoded instructions for a media player. The identification service may be implemented at a node remote from the media player, or distributed between one or more remote nodes and one or more local components in the media player. The digital medium may comprise any of various forms such as, for example, optical disc media, electronic memory media, or magnetic media.

In another aspect, a method for enabling end-use differentiation in digital media may include encoding a digital medium with video content, and determining a set of identifiers for the digital medium. The set of identifiers may include a volume name, a book type, and a time stamp for the digital medium, a file directory hash, and a watermark description. The method may further include registering the set of identifiers in an electronic registry associated with an end-use designation for the digital medium selected from rental or sell-through.

In other aspects, the method may include determining the file directory hash by hashing a file directory of the digital medium using a hashing algorithm. In addition, the method may include altering the video content according to the watermark description.

A more complete understanding of the methods and systems for identification and end-use differentiation in digital media will be afforded to those skilled in the art, as well as a realization of additional advantages and objects thereof, by a consideration of the following detailed description. Reference will be made to the appended sheets of drawings which will first be described briefly.

### BRIEF DESCRIPTION OF THE DRAWINGS

FIG. 1 is a block diagram showing elements of a computer system for identification and end-use differentiation in digital media.

FIG. 2 is a block diagram showing aspects of a digital audio-video medium for use with systems and methods described herein.

FIG. 3 is a flow chart showing an example of a method for identification of media titles, detection of pirated media and discrimination between rental and sell-through media.

FIG. 4 is a flow chart showing a method for producing a computer-readable medium article.

FIG. 5 is a block diagram showing an apparatus for performing a method such as shown in FIG. 3.

### DETAILED DESCRIPTION

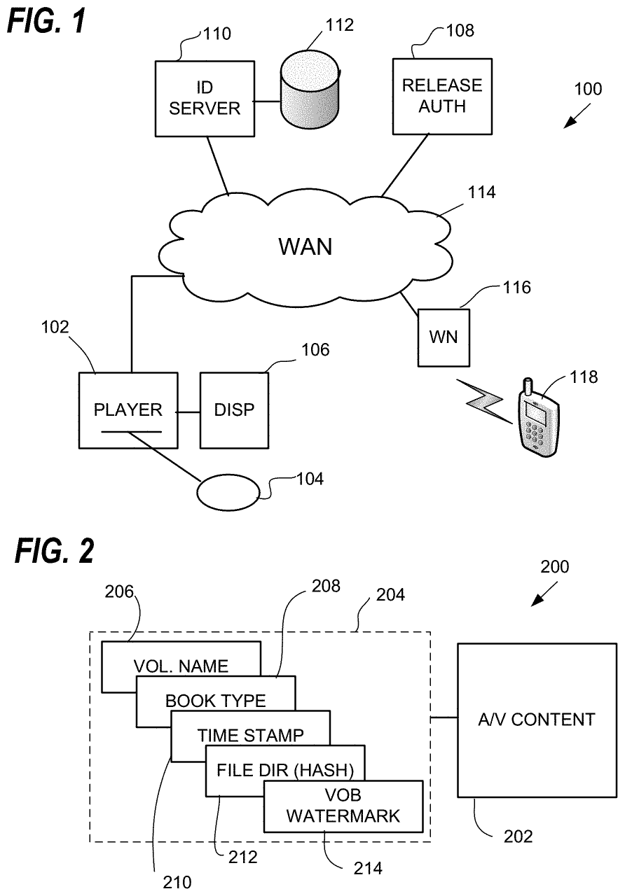

An example of a system 100 including aspects of end-use identification in digital media is shown in FIG. 1. The system may comprise a media player 102, for example, a DVD player, for reading a digital medium 104, for example, a DVD disc or similar optical medium. Player 102 may comprise a processor, media reader, memory, and computer graphics display driver for providing video output to a display device 106. Digital audio-video content may be encoded on the medium 104. Player 102 may be configured to decrypt, decode and decompress encoded content for providing a video signal for the display 106. In addition, the player may be configured to store decoded data from medium 104 in a memory for use in making authorized copies; for example, by transmitting to another player device or writing to a backup storage medium.

The player device 102 may further comprise a network interface for communicating via a wide area network (WAN) 114, for example, the Internet. Via such an interface and network, the player device may communicate with an identification server 110 serving registration information for DVD titles from a registration database 112. Database 112 may store identification data as described herein in association with SKUs for released DVD titles. Registration data may be created and registered by publishers of digital media, and communicated to the identification server for registration using one or more release authorization clients 108 operated by content publishers.

System 100 may further comprise one or more wireless networks coupled to WAN 114, for communicating with one or more wireless devices 118. It is contemplated that a wireless device 118 may receive digital content, for example, a portable version of a motion picture release, in response to an identification and content differentiation process as described herein.

FIG. 2 is a block diagram showing aspects of a digital audio-video medium 200, for example, a DVD release of a motion picture title. Content 200 may comprise digital audio-video content 202, for example encoded video object (VOB) files. Content 200 may be coupled to identification data 204, such as by being encoded together in a digital medium, for example, a DVD disc medium.

Identification data for the medium 200 may include a volume name 206, a book type 208, and a time/date stamp 212. These identifiers are determined for a release during the authoring process. The volume name 206 is the name assigned to the disc image during the authoring process. Book type 208 is an identifier that indicates the physical format type of the disc, for example, DVD-ROM, DVD-RAM, DVD-R, DVD-RW, etc. The book type identifier may be contained in the first DVD sector. Time stamp 210 refers to the date of the disc image. The volume name, book type, and time stamp constitute information that is normally included in the disc image as part of conventional disc authoring.

Identification data for the medium 200 may further include a file directory hash 210. The hash of the disc file directory structure may be generated using any suitable hashing algorithm, using the disc file directory as input. The resulting hash value is not encoded with the disc image. Instead, the hash value may be stored in a separate location, for example, an identification database, e.g., database 112. The hash value may be computed at any time after the disc image is finalized, prior to registration.

Identification data for the medium 200 may further include a VOB watermark 214. A watermark is defined by distinctive alterations to selected encoded audio-video data in the disc image. The encoded data is selected so that the watermark is not perceivable to the end user. However, the bit pattern is recognizable using algorithmic processing of the disc image. Various digital watermarking techniques are known in the art, and any suitable technique may be used. The watermark is created by altering the final disc image data to produce the watermarked disc image. The watermarked disc image becomes the master image for replication.

In an aspect of the technology, selected identifiers are used for different identification purposes. The volume name, hashed file directory structure, and time stamp may be used for title identification; that is for recognizing a particular released titled, whether for rental or sell-through. These identifiers plus the book type may be used to identify suspected pirated DVD copies. Although not 100% accurate, preliminary tests showed that this combination of attributes can presently be used to correctly identify most pirated versions of DVD releases. The volume name, time stamp, and watermark may be used to differentiate (i.e., discriminate) between a rental DVD and a sell-through DVD. Thus, three separate identification functions may be performed using the five identifiers discussed above.

Production of DVD media for identification as disclosed herein may entail separate authoring processes (“Case #1”) or a single authoring process followed by separate watermarking processes (“Case #2”) for the rental and sell-through SKUs. In both cases, separate SKUs are obtained for the rental and sell-through discs, which may be registered with the identification data in the registration database. Subsequently, these discs can be differentiated from each other using registration database and the identifiers extracted from each disc as described herein.

In Case #1, separate SKU's are obtained for the rental and sell-through versions prior to disc authoring, and separate disc images are created for the two SKUs in independent authoring processes. Subsequently, the two images are processed separately, including watermarking, mastering, replication and quality control, approval of each SKU, and registration of each SKU with a registration service provider. In Case #2, separate SKU's are obtained for the rental and sell-through versions, but a single disc image is created in a single authoring process. Different volume names are selected for the rental and sell-through versions, starting with the same disc image. Subsequently, the two images are processed separately as in Case #1.

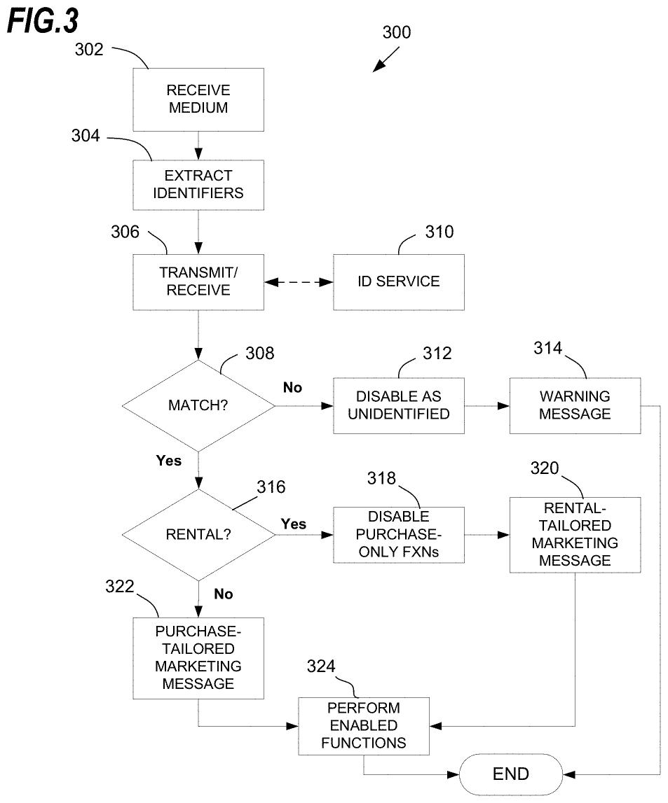

FIG. 3 shows an example of a method 300 for identification of DVD titles, detection of pirated media and discrimination between rental and sell-through media. At 302, a player device receives a digital medium. The medium includes the information as described above in relation to FIG. 2. In the basic case the receiving may be performed by a player device receiving a DVD disc in its disc reader; however, receiving 302 may encompass other actions, for example a computer receiving a downloaded digital file or a wireless device receiving a file through a wireless transmission. At 304, the player device extracts the identifiers described above. All five of the identifiers may be extracted; or in a more limited case some subset of these. Additional identifiers may also be extracted. The volume name, book type, and time stamp may simply be read and decoded from the digital medium. The file directory hash may be extracted by decoding and hashing the medium's file directory, using a hashing tool installed on the player device. A descriptor or identifier of the watermark may be extracted directly from the disc image without decoding, using a watermark-reading tool installed on the player device.

The watermark-reading tool processes the video data and recognizes whether or not a watermark is present, and if present, determines an identifier or descriptor for the watermark. As used herein, a watermark description refers generally to an identifier or descriptor determined by a watermark-reading tool for a watermark. A read watermark may be said to match an encoded watermark when the watermark description matches the identifier or descriptor registered for the watermark by the service that created it.

At 306, the player device may transmit the extracted information to an identification service 310. The identification service may be performed using a remote database as described above. In the alternative, or in addition, the service may be performed locally to the player device, independently of, or in cooperation with, a remote service. Also at 306, the player receives a response back from the identification service 310, identifying three separate characteristics of the medium: (1) the release title; (2) whether or not the medium is pirated; and (3) whether the medium is for rental or sell-through.

At 308, if the matching identifiers indicate that the medium is not pirated—i.e., all the necessary identifiers match the registered values and the medium is authenticated—then the player discriminates between rental and sell-through media at 316. As used herein, an “authorization status” means an indication of whether or not the medium is pirated. If the registration data matches a rental-only medium, then the player device may disable 318 certain functions that are not permitted for rental media, for example, copying. At the same time, other functions such as play remain enabled. At 320, the player device may present a marketing message that is tailored to rental consumers. This marketing message may be recovered by the player device from memory or requested from a remote location in response to determining that the medium is for rental only.

Referring again to 316, if the registration data indicates a sell-through or unrestricted medium, no player functions need be disabled. For example, the player device may be permitted to make a digital copy, or a limited number of digital copies. At 322, the player device may present a marketing message that is tailored to sell-through consumers. This marketing message may be recovered by the player device from memory or requested from a remote location in response to determining that the medium is for sell-through. At 324, the player device may perform all enabled functions for the identified, non-pirated medium, until play is terminated by the end user.

Referring again to 308, if the registration data indicates a pirated or unidentified medium, most or all player functions related to the medium may be disabled 312. For example, the player device may not be permitted to decode or play the medium, and not to make any digital copy. At 314, the player device may present a warning message that is tailored to consumers of pirated content. This marketing message may be recovered by the player device from memory or requested from a remote location in response to determining that the medium is unidentified or pirated. After displaying the warning message, the player device may terminate further processing of the digital medium.

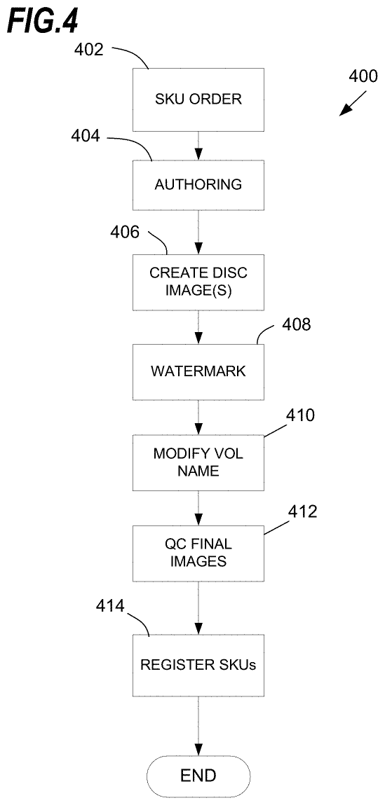

On the production side, media may be produced for use with method 300 or similar methods, using a method 400 as shown in FIG. 4. At 402, a producer, e.g., DPM, orders separate SKUs for rental and sell-through media of a content title release. The content title may be assembled, compressed, authored and quality checked in a conventional fashion at 404. Optionally, content packages for disc images are separately authored for the rental and sell-through SKUs. In the alternative, a single content package is authored 404. Likewise, at 406, either a single disc image is prepared, or separate disc images are prepared, depended on the number of content packages prepared.

At 408, the disc image or disc images are separately watermarked to provide distinctive watermarked images and disc volumes. In addition, if the separate watermarked images are prepared from a single image, the disc volume name for the watermarked rental image may be modified 410 to be distinctive from the sell-through image, or vice-versa. At 412, quality control on the watermarked disc images may be separately performed for the rental and sell-through images to create separate master images for the rental and sell-through media.

Once the quality control 412 is completed and the SKUs are received, the identifiers as described herein for the rental medium and for the sell-through medium are defined and registered in a database with the assigned SKUs. The rental and sell-though media may then be replicated from the master images in a conventional fashion.

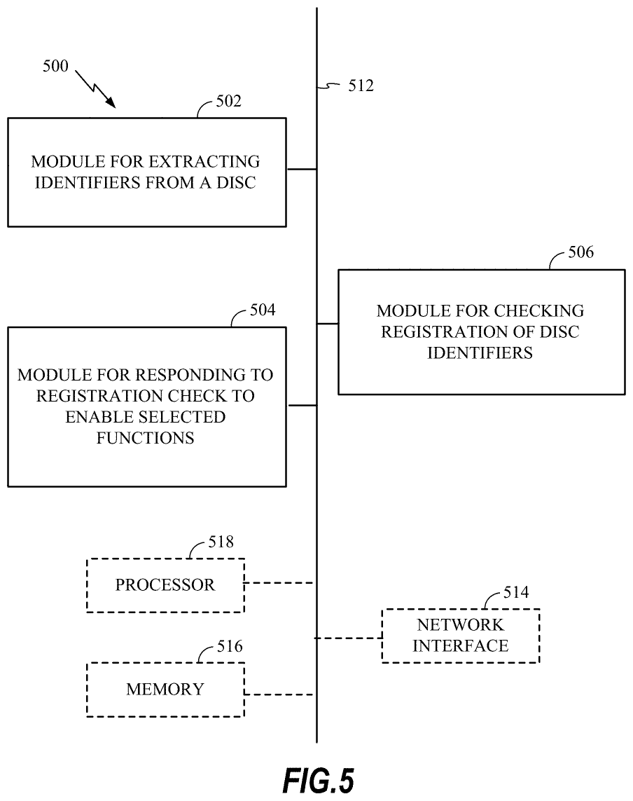

Consistent with method 300, and as further illustrated by FIG. 5, an apparatus 500 may function as a player or client for using digital audio-video content. The apparatus 500 may comprise an electronic component or module 502 for extracting the identifiers as described herein from an optical disc medium or other digital medium. The apparatus 500 may comprise an electronic component or module 506 for checking a registration database to determine a checked status of the digital medium. In addition, the apparatus 500 may comprise an electronic component or module 502 for responding to the check of the registration database to enable or disable selected functions of the player or client with respect to handling the digital medium, and/or to select additional content for output from the player device or client.

The apparatus 500 may optionally include a processor module 518 having at least one processor; in the case of the apparatus 500 this may be configured as a media player device, rather than as a general purpose microprocessor. The processor 518, in such case, may be in operative communication with the modules 502-506 via a bus 512 or similar communication coupling. The processor 518 may effect initiation and scheduling of the processes or functions performed by electrical components 502-506.

In related aspects, the apparatus 500 may include a network interface module 514. In further related aspects, the apparatus 500 may optionally include a module for storing information, such as, for example, a memory device/module 516. The computer readable medium or the memory module 516 may be operatively coupled to the other components of the apparatus 500 via the bus 512 or the like. The memory module 516 may be adapted to store computer readable instructions and data for effecting the processes and behavior of the modules 502-506, and subcomponents thereof, or the processor 518, or the methods disclosed herein, and other operations for content identification, playing, copying, and other use. The memory module 516 may retain instructions for executing functions associated with the modules 502-506. While shown as being external to the memory 516, it is to be understood that the modules 502-506 may exist at least partly within the memory 516.

As used in this application, the terms “component”, “module”, “system”, and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

Various aspects will be presented in terms of systems that may include a number of components, modules, and the like. It is to be understood and appreciated that the various systems may include additional components, modules, etc. and/or may not include all of the components, modules, etc. discussed in connection with the figures. A combination of these approaches may also be used. The various aspects disclosed herein can be performed on electrical devices including devices that utilize touch screen display technologies and/or mouse-and-keyboard type interfaces. Examples of such devices include computers (desktop and mobile), smart phones, personal digital assistants (PDAs), and other electronic devices both wired and wireless.

In addition, the various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Furthermore, the one or more versions may be implemented as a method, apparatus, or article of manufacture using standard programming and/or engineering techniques to produce software, firmware, hardware, or any combination thereof to control a computer to implement the disclosed aspects. The term “article of manufacture” (or alternatively, “computer program product”) as used herein is intended to encompass a computer program accessible from any computer-readable device or storage medium. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Of course, those skilled in the art will recognize many modifications may be made to this configuration without departing from the scope of the disclosed aspects.

The steps of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed aspects is provided to enable any person skilled in the art to make or use the present disclosure. Various modifications to these aspects will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

In view of the exemplary systems described supra, methodologies that may be implemented in accordance with the disclosed subject matter have been described with reference to several flow diagrams. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described herein. Additionally, it should be further appreciated that the methodologies disclosed herein are capable of being stored on an article of manufacture to facilitate transporting and transferring such methodologies to computers. The term article of manufacture, as used herein, is intended to encompass a computer program accessible from any computer-readable device or medium.

It should be appreciated that any patent, publication, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein, will only be incorporated to the extent that no conflict arises between that incorporated material and the existing disclosure material.

What is claimed is:

1. A method for operating a media player to provide end-use differentiation in digital media, comprising:
extracting a set of identifiers from a digital medium holding an encoded video content, using a media player;
transmitting the set of identifiers to an identification service to obtain status information indicating a title for the video content, an authorization status of the digital medium, and an end-use designation for the digital medium selected from rental or sell-through; and
controlling at least one function of the media player used to provide video output from the media player, in response to the status information.

2. The method of claim 1, wherein extracting the set of identifiers comprises extracting five identifiers comprising a volume name, a book type, and a time stamp for the digital medium, a file directory hash, and a watermark description.

3. The method of claim 2, further comprising decoding and hashing a file directory of the digital medium to obtain the file directory hash.

4. The method of claim 2, further comprising processing the video content using a watermark-reading tool to obtain the watermark description.

5. The method of claim 1, further comprising disabling play of the video content in response to the authorization status indicating the digital medium is not authorized for play.

6. The method of claim 1, further comprising enabling play and copying of the video content, in response to the authorization status indicating the digital medium is authorized for play and the end-use designation is for sell-through.

7. The method of claim 1, further comprising enabling play and disabling copying of the video content, in response to the authorization status indicating the digital medium is authorized for play and the end-use designation is for rental.

8. The method of claim 1, further comprising selecting a message for outputting from the video player, in response to the status information.

9. An apparatus for providing end-use differentiation in digital media, comprising:
at least one processor configured for extracting a set of identifiers from a digital medium holding an encoded video content, transmitting the set of identifiers to an identification service to obtain status information indicating a title for the video content, an authorization status of the digital medium, and an end-use designation for the digital medium selected from rental or sell-through, and controlling at least one media player function for providing video output from the media player, in response to the status information; and
a memory coupled to the at least one processor for storing data.

10. The apparatus of claim 9, wherein the at least one processor is further configured for extracting the set of identifiers comprising five identifiers comprising a volume name, a book type, and a time stamp for the digital medium, a file directory hash, and a watermark description.

11. The apparatus of claim 10, wherein the at least one processor is further configured for decoding and hashing a file directory of the digital medium to obtain the file directory hash.

12. The apparatus of claim 10, wherein the at least one processor is further configured for processing the video content using a watermark-reading tool to obtain the watermark description.

13. The apparatus of claim 9, wherein the at least one processor is further configured for disabling play of the video content in response to the authorization status indicating the digital medium is not authorized for play.

14. The apparatus of claim 9, wherein the at least one processor is further configured for enabling play and copying of the video content, in response to the authorization status indicating the digital medium is authorized for play and the end-use designation is for sell-through.

15. The apparatus of claim 9, wherein the at least one processor is further configured for enabling play and disabling copying of the video content, in response to the authorization status indicating the digital medium is authorized for play and the end-use designation is for rental.

16. A method for enabling end-use differentiation in digital media, comprising:
encoding a digital medium with video content;
determining a set of identifiers for the digital medium, comprising a volume name, a book type, and a time stamp for the digital medium, a file directory hash, and a watermark description; and
registering the set of identifiers in an electronic registry associated with an end-use designation for the digital medium selected from rental or sell-through.

17. The method of claim 23, further comprising determining the file directory hash by hashing a file directory of the digital medium using a hashing algorithm.

18. The method of claim 23, further comprising altering the video content according to the watermark description.
